(19) United States
(12) Patent Application Publication
(10) Pub. No.: US 2020/0399503 A1
(43) Pub. Date: Dec. 24, 2020

(54) COMPOSITION FOR FORMING HARDCOAT LAYER, HARDCOAT FILM, ARTICLE AND IMAGE DISPLAY DEVICE HAVING HARDCOAT FILM, AND METHOD FOR MANUFACTURING HARDCOAT FILM

(71) Applicant: FUJIFILM Corporation, Tokyo (JP)

(72) Inventors: Tetsu KITAMURA, Kanagawa (JP); Akio TAMURA, Kanagawa (JP); Yuta FUKUSHIMA, Kanagawa (JP)

(73) Assignee: FUJIFILM Corporation, Tokyo (JP)

(21) Appl. No.: 17/010,174

(22) Filed: Sep. 2, 2020

Related U.S. Application Data
(63) Continuation of application No. PCT/JP2019/010929, filed on Mar. 15, 2019.

(30) Foreign Application Priority Data
Mar. 30, 2018 (JP) 2018-069955

(51) Int. Cl. C09D 183/06; C08G 77/14; G02B 1/14

(52) U.S. Cl. CPC C09D 183/06; G02B 1/14; C08G 77/14

(57) ABSTRACT

A composition for forming a hardcoat layer includes a polyorganosilsesquioxane; and a polymerization initiator, in which the polyorganosilsesquioxane has, at least, a siloxane constitutional unit containing an oxetanyl group and a siloxane constitutional unit containing an epoxy group and is represented by the General Formula (1), in the General Formula (1), Ra represents a group containing an oxetanyl group; Rb represents a group containing an epoxy group; Rc represents a monovalent substituent; Ra, Rb, and Rc each have a structure including none of an amide bond, a urea bond, and a urethane bond; p and q represent an integer equal to or greater than 1; r represents an integer equal to or greater than 0; p/q is equal to or greater than 1.0 and less than 99.

### CROSS REFERENCE TO RELATED APPLICATION

This is a continuation of International Application No. PCT/JP2019/010929 filed on Mar. 15, 2019, and claims a priority from Japanese Patent Application No. 2018-069955 filed on Mar. 30, 2018, the entire disclosures of which are incorporated herein by reference.

### BACKGROUND OF THE INVENTION

### 1. Field of the Invention

The present invention relates to a composition for forming a hardcoat layer, a hardcoat film, an article and an image display device that have the hardcoat film, and a method for manufacturing the hardcoat film.

### 2. Description of the Related Art

For image display devices such as a display device using a cathode ray tube (CRT), a plasma display panel (PDP), an electroluminescence display (ELD), a vacuum fluorescent display (VFD), a field emission display (FED), and a liquid crystal display (LCD), in order to prevent the display surface from being scratched, it is preferable to provide an optical film (hardcoat film) having a hardcoat layer on a substrate.

As a composition for forming a hardcoat layer, for example, JP1999-029640A (JP-H11-029640A) describes a photocationic curable composition consisting of a silsesquioxane compound having an oxetanyl group.

JP2005-179543A describes a silica sol obtained by hydrolyzing a silicon compound containing an epoxy group.

WO2015/053397A and JP2005-092099A describe a curable composition containing a silsesquioxane compound having an epoxy group and an oxetanyl group, in which the proportion of the epoxy group is higher than the proportion of the oxetanyl group.

### SUMMARY OF THE INVENTION

In recent years, for example, in smartphones and the like, there has been an increasing need for flexible displays. Accordingly, there has been a strong demand for an optical film that is hardly broken even though the film is repeatedly folded (an optical film having excellent resistance to repeated folding).

However, according to the examination performed by the inventors of the present invention, it has been revealed that the hardcoat film formed of the composition for a hardcoat layer described in JP1999-029640A (JP-H11-029640A), JP2005-179543A, WO2015/053397A, and JP2005-092099B cannot simultaneously achieve hardness, rub resistance, and resistance to repeated folding.

An object of the present invention is to provide a composition for forming a hardcoat layer that can form a hardcoat layer having high hardness, excellent rub resistance, and excellent resistance to repeated folding, a hardcoat film formed of the composition for forming a hardcoat layer described above, an article and an image display device that have the hardcoat film, and a method for manufacturing the hardcoat film.

As a result of intensive examination, the inventors of the present invention have found that the above object can be achieved by the following means.

[1] A composition for forming a hardcoat layer, including a polyorganosilsesquioxane and a polymerization initiator, in which the polyorganosilsesquioxane has, at least, a siloxane constitutional unit containing an oxetanyl group and a siloxane constitutional unit containing an epoxy group and is represented by the following General Formula (1).

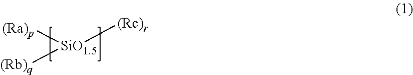

In the General Formula (1), Ra represents a group containing an oxetanyl group, Rb represents a group containing an epoxy group, and Rc represents a monovalent substituent. Ra, Rb, and Rc each have a structure including none of an amide bond, a urea bond, and a urethane bond. p and q represent an integer equal to or greater than 1, and r represents an integer equal to or greater than 0. Here, p/q is equal to or greater than 1.0 and less than 99. In a case where each of p, q, and r is an integer equal to or greater than 2, a plurality of Ra's may be the same as or different from each other, a plurality of Rb's may be the same as or different from each other, and a plurality of Rc's may be the same as or different from each other. In a case where r is an integer equal to or greater than 2, a plurality of Rc's may form a bond with each other.

[2] The composition for forming a hardcoat layer described in [1], in which in the General Formula (1), (p+q)/(p+q+r) is 0.5 to 1.0.

[3] The composition for forming a hardcoat layer described in [1] or [2], in which Ra in the General Formula (1) is a group represented by the following General Formula (1a).

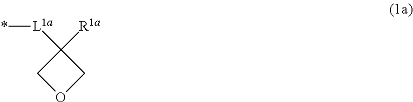

In the General Formula (1a), * represents a portion linked to Si in the General Formula (1), L^{1a} represents a divalent linking group, and R^{1a} represents a substituted or unsubstituted alkyl group having 1 to 6 carbon atoms. Here, L^{1a} includes none of an amide bond, a urea bond, and a urethane bond.

[4] The composition for forming a hardcoat layer described in any one of [1] to [3], in which Rb in the General Formula (1) is a group having a condensed ring structure of an epoxy group and an alicyclic group.

[5] The composition for forming a hardcoat layer described in any one of [1] to [4], in which Rb in the General Formula (1) is a group having an epoxycyclohexyl group.

[6] The composition for forming a hardcoat layer described in any one of [1] to [5], in which in the General Formula (1), r is an integer equal to or greater than 2, a plurality of Rc's form a bond with each other, and r/(p+q+r) is 0.005 to 0.20.

[7] The composition for forming a hardcoat layer described in any one of [1] to [6], in which a weight-average molecular weight of the polyorganosilsesquioxane is 2,000 to 20,000.

[8] A hardcoat film including a substrate and a hardcoat layer which is on the substrate and formed of the composition for forming a hardcoat layer described in any one of [1] to [7].

[9] The hardcoat film described in [8], in which the substrate is a plastic substrate.

[10] An article having the hardcoat film described in [8] or [9].

[11] An image display device having the hardcoat film described in [8] or [9] as a surface protection film.

[12] A method for manufacturing a hardcoat film, including (I) coating a substrate with the composition for forming a hardcoat layer described in any one of [1] to [7] so as to form a coating film on the substrate, and (II) performing a curing treatment on the coating film so as to form a hardcoat layer.

The film having a hardcoat layer formed of the composition for forming a hardcoat layer according to an embodiment of the present invention that includes a specific polyorganosilsesquioxane and the like has high hardness, excellent rub resistance, and excellent resistance to repeated folding. The mechanism that allows the film to exhibit the above properties is unclear, but is assumed to be as below by the inventors of the present invention.

The specific polyorganosilsesquioxane used in the present invention has an inorganic structure (a structure formed by a siloxane bond) and organic crosslinking groups (an epoxy group and an oxetanyl group) that form an organic crosslink by a polymerization reaction. In a film obtained from this compound, an interpenetrating polymer network (IPN) structure is formed in which the network of the inorganic structure and the network formed of the organic crosslinking groups mutually penetrate. It is considered that as a result, high hardness and rub resistance resulting from the inorganic structure and resistance to repeated folding resulting from the organic crosslink may be simultaneously achieved.

Furthermore, the polyorganosilsesquioxane used in the present invention contains both the epoxy group and oxetanyl group, in which the proportion of the oxetanyl group is higher than the proportion of the epoxy group. Regarding the photopolymerization rate, it is considered that at the early stage of reaction, the photopolymerization rate of the epoxy group undergoing serious ring distortion may be higher than that of the oxetanyl group, but at the middle to late stages of the growth reaction, the polymerization rate of the oxetanyl group having a high basicity may be higher. Furthermore, it is considered that the final degree of polymerization may be higher in the oxetanyl group. It is considered that the polyorganosilsesquioxane used in the present invention may exploit the high reactivity of the epoxy group at the early stage and fully utilize the high reactivity of the oxetanyl group at the lat stage. It is considered that as a result, a cured product with a higher polymerization rate may be obtained, and the three performances described above could be simultaneously achieved at a higher level.

The polyorganosilsesquioxane used in the present invention includes none of an amide bond, a urea bond, and a urethane bond in the structure thereof. In a case where the polyorganosilsesquioxane has the above bonds having high polarity, the IPN structure is not formed. It is considered that accordingly, the hardness and resistance to repeated folding may be reduced.

According to the present invention, it is possible to provide a composition for forming a hardcoat layer that has high hardness, excellent resistance to repeated folding, and excellent rub resistance, a hardcoat film formed of the composition for forming a hardcoat layer, an article and an image display device that have the hardcoat film, and a method for manufacturing the hardcoat film.

### DESCRIPTION OF THE PREFERRED EMBODIMENTS

Hereinafter, embodiments of the present invention will be specifically described, but the present invention is not limited thereto. In the present specification, in a case where numerical values represent a value of physical properties, a value of characteristics, and the like, the description of “(numerical value 1) to (numerical value 2)” means “equal to or greater than (numerical value 1) and equal to or smaller than (numerical value 2)”. Furthermore, “(meth)acrylate” represents at least one of acrylate and methacrylate, “(meth)acryl” represents at least one of acryl and methacryl, and “(meth)acryloyl” represents at least one of acryloyl and methacryloyl.

[Composition for Forming Hardcoat Layer]

The composition for forming a hardcoat layer according to an embodiment of the present invention includes at least a specific polyorganosilsesquioxane represented by General Formula (1) and a polymerization initiator. Hereinafter, each component included in the composition for forming a hardcoat layer according to the embodiment of the present invention (also referred to as “composition according to the embodiment of the present invention”) will be specifically described.

<Polyorganosilsesquioxane>

The polyorganosilsesquioxane included in the composition for forming a hardcoat layer according to an embodiment of the present invention (also referred to as “polyorganosilsesquioxane of the present invention”) has at least a siloxane constitutional unit containing an oxetanyl group and a siloxane constitutional unit containing an epoxy group and is represented by General Formula (1).

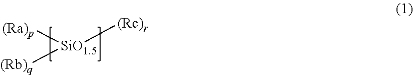

In General Formula (1), Ra represents a group containing an oxetanyl group, Rb represents a group containing an epoxy group, and Rc represents a monovalent substituent. Ra, Rb, and Rc each have a structure including none of an amide bond, a urea bond, and a urethane bond. p and q represent an integer equal to or greater than 1, and r represents an integer equal to or greater than 0. Here, p/q is equal to or greater than 1.0 and less than 99. In a case where each of p, q, and r is an integer equal to or greater than 2, a plurality of Ra's may be the same as or different from each other, a plurality of Rb's may be the same as or different from each other, and a plurality of Rc's may be the same as or different from each other. In a case where r is an integer equal to or greater than 2, a plurality of Rc's may form a bond with each other.

[SiO_{1.5}] in General Formula (1) represents a structural portion composed of a siloxane bond (Si—O—Si) in the polyorganosilsesquioxane.

The polyorganosilsesquioxane is a network-type polymer or polyhedral cluster having a siloxane constitutional unit derived from a hydrolyzable trifunctional silane compound, and can form a random structure, a ladder structure, a cage structure, and the like by a siloxane bond. In the present invention, the structural portion represented by [SiO_{1.5}] may be any of the above structures or a mixture of a plurality of structures. The proportion of the random structure or ladder structure in the entire structural portion represented by [SiO_{1.5}] is preferably equal to or higher than 50%, more preferably equal to or higher than 70%, and even more preferably equal to or higher than 80%.

In General Formula (1), Ra represents a group containing an oxetanyl group. Here, the structure of Ra includes none of an amide bond, a urea bond, and a urethane bond.

Examples of the group containing an oxetanyl group include known groups having an oxetane ring.

Ra is preferably a group represented by General Formula (1a).

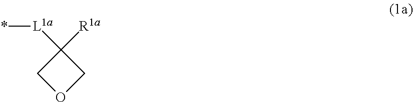

In General Formula (1a). * represents a portion linked to Si in General Formula (1), L^{1a} represents a divalent linking group, and R^{1a} represents a substituted or unsubstituted alkyl group having 1 to 6 carbon atoms. Here, L^{1a} includes none of an amide bond, a urea bond, and a urethane bond.

Examples of the divalent linking group represented by L^{1a} include a substituted or unsubstituted alkylene group having 1 to 10 carbon atoms, —O—, —CO—, —COO—, —S—, and a divalent linking group obtained by combining these.

R^{1a} represents a substituted or unsubstituted alkyl group having 1 to 6 carbon atoms.

Examples of the alkyl group having 1 to 6 carbon atoms include a methyl group, an ethyl group, a n-propyl group, an i-propyl group, a n-butyl group, a n-hexyl group, and the like.

In a case where the alkyl group has a substituent, examples of the substituent include a hydroxyl group, a carboxyl group, an alkoxy group, an aryl group, a heteroaryl group, a halogen atom, a nitro group, a cyano group, a silyl group, and the like.

R^{1a} is preferably an unsubstituted linear alkyl group having 1 to 3 carbon atoms, and more preferably a methyl group or an ethyl group.

The group represented by General Formula (1a) is preferably a group represented by General Formula (2a).

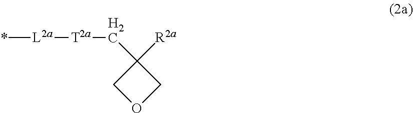

In General Formula (2a), * represents a portion linked to Si in General Formula (1), L^{2a} represents a substituted or unsubstituted alkylene group having 1 to 10 carbon atoms, T^{2a} represents —O— or —COO—, and R^{2a} represents a substituted or unsubstituted alkyl group having 1 to 6 carbon atoms. Here, L^{2a} may have —S— between carbon-carbon bonds in the alkylene group.

L^{2a} represents a substituted or unsubstituted alkylene group having 1 to 10 carbon atoms. Here, L^{2a} may have —S— between carbon-carbon bonds in the alkylene group.

Examples of the alkylene group having 1 to 10 carbon atoms include a methylene group, an ethylene group, a propylene group, an isopropylene group, a n-butylene group, an isobutylene group, a s-butylene group, a t-butylene group, a n-pentylene group, an isopentylene group, a s-pentylene group, a t-pentylene group, a n-hexylene group, an isohexylene group, a s-hexylene group, a t-hexylene group, a n-heptylene group, an isoheptylene group, a s-heptylene group, a t-heptylene group, a n-octylene group, an isooctylene group, a s-octylene group, a t-octylene group, and the like.

In a case where the alkylene group has a substituent, examples of the substituent include a hydroxyl group, a carboxyl group, an alkoxy group, an aryl group, a heteroaryl group, a halogen atom, a nitro group, a cyano group, a silyl group, and the like.

L^{2a} is preferably an alkylene group having 1 to 7 carbon atoms, and more preferably an alkylene group having 2 to 4 carbon atoms.

L^{2a} is preferably an unsubstituted alkylene group.

T^{2a} represents —O— or —COO—. Herein, the carbon atom in the —COO— group is linked to L^{2a} in General Formula (2a).

R^{2a} represents a substituted or unsubstituted alkyl group having 1 to 6 carbon atoms. R^{2a} has the same definition as R^{1a} in General Formula (1a), and the preferred examples thereof are also the same.

Ra in General Formula (1) is derived from a group (a group other than an alkoxy group and a halogen atom; for example, Ra in a hydrolyzable silane compound represented by Formula (A) which will be described later, or the like) bonded to a silicon atom in the hydrolyzable trifunctional silane compound used as a raw material of the polyorganosilsesquioxane.

Specific examples of Ra are as below, but the present invention is not limited thereto. In the following specific examples, * represents a portion linked to Si in General Formula (1).

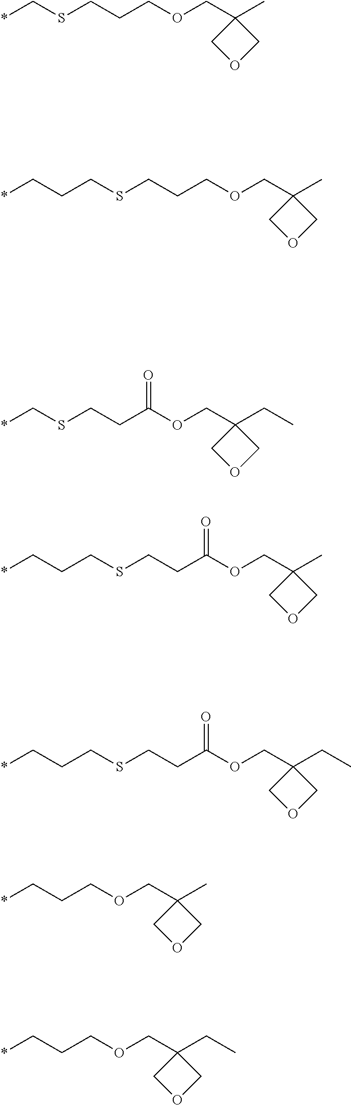

In general Formula (1), Rb represents a group containing an epoxy group. Here, the structure of Rb includes none of an amide bond, a urea bond, and a urethane bond.

Examples of the group containing an epoxy group include known and widely used groups having an oxirane ring.

Rb is preferably a group represented by the following Formulas (1b) to (4b).

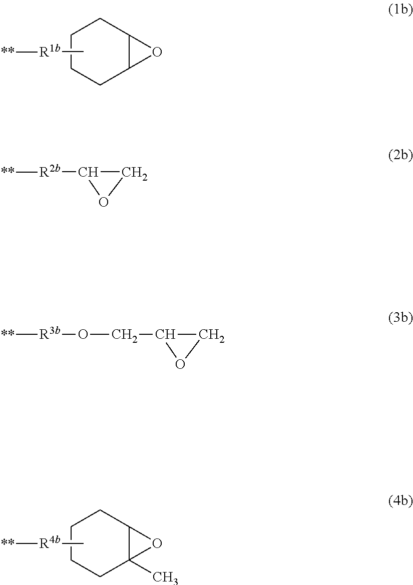

In Formulas (1b) to (4b), ** represents a portion linked to Si in General Formula (1), and R^{1b}, R^{2b}, R^{3b}, and R^{4b} represent a substituted or unsubstituted alkylene group.

The alkylene group represented by R^{1b}, R^{2b}, R^{3b}, and R^{4b} is preferably a linear or branched alkylene group having 1 to 10 carbon atoms, and examples thereof include a methylene group, a methyl methylene group, a dimethyl methylene group, an ethylene group an i-propylene group, a n-propylene group, a n-butylene group, a n-pentylene group, a n-hexylene group, a n-decylene group, and the like.

In a case where the alkylene group represented by R^{1b}, R^{2b}, R^{3b}, and R^{4b} has a substituent, examples of the substituent include a hydroxyl group, a carboxyl group, an alkoxy group, an aryl group, a heteroaryl group, a halogen atom, a nitro group, a cyano group, a silyl group, and the like.

As R^{1b}, R^{2b}, R^{1b}, and R^{4b}, from the viewpoint of the surface hardness of the cured product and the curing properties, an unsubstituted linear alkylene group having 1 to 4 carbon atoms and an unsubstituted branched chain having 3 or 4 carbon atoms are preferable, an ethylene group, a n-propylene group, or an i-propylene group is more preferable, and an ethylene group or an n-propylene group is even more preferable.

Rb is preferably a group having a condensed ring structure of an epoxy group and an alicyclic group, more preferably a group having an epoxycyclohexyl group, and even more preferably a group represented by Formula (1b).

Rb in General Formula (1) is derived from a group (a group other than an alkoxy group and a halogen atom; for example, Rb in a hydrolyzable silane compound represented by Formula (B) which will be described later, or the like) bonded to a silicon atom in the hydrolyzable trifunctional silane compound used as a raw material of the polyorganosilsesquioxane.

Specific examples of Rb are as below, but the present invention is not limited thereto. In the following specific examples, ** represents a portion linked to Si in General Formula (1).

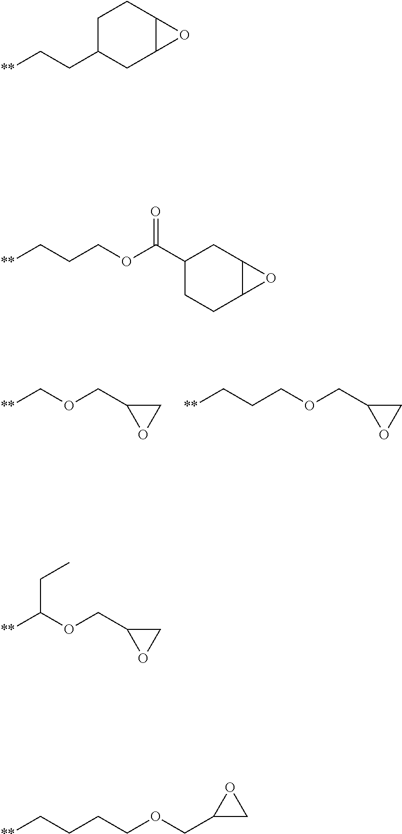

In General Formula (1), Rc represents a monovalent substituent. Here, the structure of Rc does not include an amide bond, a urea bond, and a urethane bond.

Examples of the monovalent substituent represented by Rc include a hydrogen atom, a substituted or unsubstituted alkyl group, a substituted or unsubstituted cycloalkyl group, a substituted or unsubstituted alkenyl group, a substituted or unsubstituted aryl group, or a substituted or unsubstituted aralkyl group.

Examples of the alkyl group represented by Rc include an alkyl group having 1 to 10 carbon atoms. Examples thereof include linear or branched alkyl groups such as a methyl group, an ethyl group, a propyl group, a n-butyl group, an isopropyl group, an isobutyl group, a s-butyl group, a t-butyl group, and an isopentyl group.

Examples of the cycloalkyl group represented by Rc include a cycloalkyl group having 3 to 15 carbon atoms. Examples thereof include a cyclobutyl group, a cyclopentyl group, a cyclohexyl group, and the like.

Examples of the alkenyl group represented by Rc include an alkenyl group having 2 to 10 carbon atoms. Examples of the alkenyl group include a linear or branched alkenyl group such as a vinyl group, an allyl group, or an isopropenyl group.

Examples of the aryl group represented by Rc include an aryl group having 6 to 15 carbon atoms. Examples thereof include a phenyl group, a tolyl group, a naphthyl group, and the like.

Examples of the aralkyl group represented by Rc include an aralkyl group having 7 to 20 carbon atoms. Examples thereof include a benzyl group, a phenethyl group, and the like.

Examples of the substituted alkyl group, substituted cycloalkyl group, substituted alkenyl group, substituted aryl group, and substituted aralkyl group described above include groups obtained in a case where some or all of hydrogen atoms or main chain skeletons in the alkyl group, cycloalkyl group, alkenyl group, aryl group, and aralkyl group described above are substituted with at least one kind of group selected from the group consisting of an ether group, an ester group, a carbonyl group, a halogen atom (such as a fluorine atom), an acryl group, a methacryl group, a mercapto group, and a hydroxy group (hydroxyl group), and the like.

Rc is preferably a substituted or unsubstituted alkyl group, and more preferably an unsubstituted alkyl group having 1 to 10 carbon atoms.

In a case where r is an integer equal to or greater than 2, a plurality of Rc's may form a bond with each other. The number of Rc's forming a bond with each other is preferably 2 or 3, and more preferably 2.

A group (Rc₂) formed by the bonding of two Rc's is preferably an alkylene group formed by the bonding of the aforementioned substituted or unsubstituted alkyl groups represented by Rc.

Examples of the alkylene group represented by Rc₂ include linear or branched alkylene groups such as a methylene group, an ethylene group, a propylene group, an isopropylene group, a n-butylene group, an isobutylene group, a s-butylene group, a t-butylene group, a n-pentylene group, an isopentylene group, a s-pentylene group, a t-pentylene group, a n-hexylene group, an isohexylene group, a s-hexylene group, a t-hexylene group, a n-heptylene group, an isoheptylene group, a s-heptylene group, a t-heptylene group, a n-octylene group, an isooctylene group, a s-octylene group, and a t-octylene group.

The alkylene group represented by Rc₂ is preferably an unsubstituted alkylene group having 2 to 20 carbon atoms, more preferably an unsubstituted alkylene group having 2 to 20 carbon atoms, even more preferably an unsubstituted alkylene group having 2 to 8 carbon atoms, and particularly preferably a n-butylene group, a n-pentylene group, a n-hexylene group, a n-heptylene group, or a n-octylene group.

A group (Rc₃) formed by the bonding of three Rc's is preferably a trivalent group obtained in a case where any one of the hydrogen atoms in the alkylene group represented by Rc₂ is removed.

Rc in General Formula (1) is derived from a group (a group other than an alkoxy group and a halogen atom; for example, R_{c1} to R_{c3} in a hydrolyzable silane compound represented by Formulas (C1) to (C3) which will be described later, or the like) bonded to a silicon atom in the hydrolyzable silane compound used as a raw material of the polyorganosilsesquioxane.

In General Formula (1), p and q represent an integer equal to or greater than 1, and r represents an integer equal to or greater than 0. Here, p/q is equal to or greater than 1.0 and less than 99.

In a case where p/q is equal to or greater than 1.0 and less than 99, a cured product with a high polymerization rate is obtained, and high hardness, rub resistance, and resistance to repeated folding can be simultaneously achieved at a high level.

p/q is preferably 1.0 to 20, more preferably 1.0 to 10, and even more preferably 1.0 to 5.0.

(p+q)/(p+q+r) is preferably 0.5 to 1.0. In a case where the amount of groups represented by Ra or Rb is equal to or greater than 50% of the total amount of the groups represented by Ra, Rb, or Rc included in the polyorganosilsesquioxane of the present invention, the network composed of the organic crosslink is sufficiently formed in the hardcoat film including the polyorganosilsesquioxane of the present invention, and the IPN structure is formed better. Therefore, the performances such as hardness, resistance to repeated folding, and rub resistance, are further improved.

(p+q)/(p+q+r) is more preferably 0.7 to 1.0, even more preferably 0.8 to 1.0, and particularly preferably 0.9 to 1.0.

It is also preferable that r in General Formula (1) is an integer equal to or greater than 2, and a plurality of Rc's form a bond with each other. In this case, r/(p+q+r) is preferably 0.005 to 0.20.

r/(p+q+r) is more preferably 0.005 to 0.20, even more preferably 0.005 to 0.10, and particularly preferably 0.005 to 0.050.

The weight-average molecular weight (Mw) of the polyorganosilsesquioxane of the present invention expressed in terms of standard polystyrene is preferably 2,000 to 20,000, more preferably 2,500 to 10,000, even more preferably 2,700 to 8,000, and particularly preferably 2,900 to 6,000.

In a case where the weight-average molecular weight is equal to or greater than 2,000, the heat resistance and rub resistance of the cured product tend to be further improved. On the other hand, in a case where the weight-average molecular weight is equal to or smaller than 20,000, the compatibility of the polyorganosilsesquioxane with other components in a curable composition tends to be improved.

The molecular weight dispersity (Mw/Mn) of the polyorganosilsesquioxane of the present invention that is measured by GPC and expressed in terms of standard polystyrene is, for example, 1.0 to 5.0, preferably 1.1 to 4.0, more preferably 1.2 to 3.5, even more preferably 1.3 to 3.0, and particularly preferably 1.45 to 2.0. In a case where the molecular weight dispersity is within the above range, the surface hardness of the cured product is further improved, the polyorganosilsesquioxane tends to be in a liquid state, and the handleability thereof tends to be improved. Mn represents a number-average molecular weight.

The weight-average molecular weight and the molecular weight dispersity of the polyorganosilsesquioxane of the present invention were measured using the following device under the following conditions.

Measurement device: trade name “LC-20AD” (manufactured by Shimadzu Corporation)

Columns: two Shodex KF-801 columns, KF-802, and KF-803 (manufactured by SHOWA DENKO K.K.)

Measurement temperature: 40° C.

Eluent: THF, sample concentration of 0.1% to 0.2% by mass

Flow rate: 1 mL/min

Detector: UV-VIS detector (trade name “SPD-20A”, manufactured by Shimadzu Corporation)

Molecular weight: expressed in terms of standard polystyrene

In the composition according to the embodiment of the present invention, one kind of polyorganosilsesquioxane described above may be used singly, or two or more kinds of polyorganosilsesquioxanes described above having different structures may be used in combination.

In the composition according to the embodiment of the present invention, the content of the polyorganosilsesquioxane with respect to the total solid content in the composition is preferably 50% by mass to 100% by mass, more preferably 50% by mass to 99.9% by mass, even more preferably 70% by mass to 99.5% by mass, and particularly preferably 90% by mass to 99.0% by mass.

<Method for Manufacturing Polyorganosilsesquioxane>

The polyorganosilsesquioxane of the present invention can be manufactured by a known polysiloxane manufacturing method and is not particularly limited. The polyorganosilsesquioxane can be manufactured preferably by a method of hydrolyzing and condensing two or more kinds of hydrolyzable silane compounds. Here, as the hydrolyzable silane compounds, it is preferable to use a hydrolyzable trifunctional silane compound (a compound represented by Formula (A)) for forming the siloxane constitutional unit containing an oxetanyl group) in the polyorganosilsesquioxane of the present invention and a hydrolyzable trifunctional silane compound (a compound represented by Formula (B)) for forming the siloxane constitutional unit containing an epoxy group in the polyorganosilsesquioxane of the present invention.

In a case where r in General Formula (1) is an integer equal to or greater than 1, as the hydrolyzable silane compounds, it is preferable to use the compounds represented by Formula (C1), (C2), or (C3) in combination.

Ra-Si(X¹)₃ (A)

Ra in Formula (A) has the same definition as Ra in General Formula (1), and preferred examples thereof are also the same.

X¹ in Formula (A) represents an alkoxy group or a halogen atom.

Examples of the alkoxy group represented by X¹ include an alkoxy group having 1 to 4 carbon atoms such as a methoxy group, an ethoxy group, a propoxy group, an isopropyloxy group, a butoxy group, and an isobutyloxy group.

Examples of the halogen atom represented by X¹ include a fluorine atom, a chlorine atom, a bromine atom, an iodine atom, and the like.

As X¹, an alkoxy group is preferable, and a methoxy group and an ethoxy group are more preferable. Three X¹'s may be the same as or different from each other.

The compound represented by Formula (A) is a compound that forms the siloxane constitutional unit having Ra in the polyorganosilsesquioxane of the present invention.

Rb—Si(X²)₃ (B)

Rb in Formula (B) has the same definition as Rb in General Formula (1), and preferred examples thereof are also the same.

X² in Formula (B) has the same definition as X¹ in Formula (A), and preferred examples thereof are also the same. Three X²'s may be the same as or different from each other.

The compound represented by Formula (B) is a compound that forms the siloxane constitutional unit having Rb in the polyorganosilsesquioxane of the present invention.

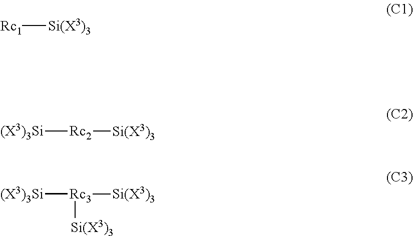

Rc₁ in Formula (C1) has the same definition as Rc in General Formula (1), and preferred examples thereof are also the same.

Rc₂ in Formula (C2) has the same definition as the group (Rc₂) formed in a case where two Rc's in General Formula (1) are bonded to each other, and preferred examples thereof are also the same.

Rc₃ in Formula (C3) has the same definition as the group (Rc₃) formed in a case where three Rc's in General Formula (1) are bonded to each other, and preferred examples thereof are also the same.

X³ in Formulas (C1) to (C3) has the same definition as X¹ in Formula (A), and preferred examples thereof are also the same. The plurality of X³'s may be the same as or different from each other.

As the hydrolyzable silane compound, hydrolyzable silane compounds other than the compounds represented by Formulas (A), (B) and (C1) to (C3) may be used in combination. Examples thereof include a hydrolyzable trifunctional silane compound, a hydrolyzable monofunctional silane compound, a hydrolyzable difunctional silane compound, and the like other than the compounds represented by Formulas (A), (B), and (C1) to (C3).

In order to adjust p/q in the polyorganosilsesquioxane of the present invention represented by General Formula (1), a mixing ratio (molar ratio) between the compound represented by Formula (A) and the compound represented by Formula (B) used for manufacturing the polyorganosilsesquioxane may be adjusted.

Specifically, for example, in order for p/q to be equal to or greater than 1.0 and less than 99, a value represented by the following (Z1) may be set to be equal to or greater than 1.0 and less than 99, and the compounds may be hydrolyzed and condensed to manufacture the polyorganosilsesquioxane.

(Z1)=compound represented by Formula (A) (molar amount)compound represented by Formula (B) (molar amount)

Furthermore, In a case where Rc in the polyorganosilsesquioxane of the present invention is derived from Rc₁ to Rc₃ in the hydrolyzable silane compounds represented by Formulas (C1) to (C3), in order to adjust (p+q)/(p+q+r) in General Formula (1), a mixing ratio (molar ratio) among the compounds represented by Formulas (A), (B) and (C1) to (C3) may be adjusted.

Specifically, for example, in order to adjust (p+q)/(p+q+r) to 0.5 to 1.0, a value represented by the following (Z2) may be set to 0.5 to 1.0, and a method of hydrolyzing and condensing these compounds may be used to manufacture the polyorganosilsesquioxane.

(Z2)={compound represented by Formula (A) (molar amount)+compound represented by Formula (B) (molar amount)}/{compound represented by Formula (A) (molar amount)+compound represented by Formula (B) (molar amount)+compound represented by Formula (C1) (molar amount)+compound represented by Formula (C2) (molar amount)×2+compound represented by Formula (C3) (molar amount)×3}

The amount of the above hydrolyzable silane compounds used and the composition thereof can be appropriately adjusted according to the desired structure of the polyorganosilsesquioxane of the present invention.

Furthermore, the hydrolysis and condensation reactions of the hydrolyzable silane compounds can be performed simultaneously or sequentially. In a case where the above reactions are sequentially performed, the order of performing the reactions is not particularly limited.

The hydrolysis and condensation reactions of the hydrolyzable silane compounds can be carried out in the presence or absence of a solvent, and are preferably carried out in the presence of a solvent.

Examples of the solvent include aromatic hydrocarbons such as benzene, toluene, xylene, and ethylbenzene; ethers such as diethyl ether, dimethoxyethane, tetrahydrofuran, and dioxane: ketones such as acetone, methyl ethyl ketone, and methyl isobutyl ketone; esters such as methyl acetate, ethyl acetate, isopropyl acetate, and butyl acetate; amides such as N,N-dimethylformamide and N,N-dimethylacetamide; nitriles such as acetonitrile, propionitrile, and benzonitrile; alcohols such as methanol, ethanol, isopropyl alcohol, and butanol, and the like.

As the solvent, ketones or ethers are preferable. One kind of solvent can be used singly, or two or more kinds of solvents can be used in combination.

The amount of the solvent used is not particularly limited, and can be appropriately adjusted according to the desired reaction time or the like such that the amount falls into a range of 0 to 2,000 parts by mass with respect to the total amount (100 parts by mass) of the hydrolyzable silane compounds.

The hydrolysis and condensation reactions of the hydrolyzable silane compounds is preferably performed in the presence of a catalyst and water. The catalyst may be an acid catalyst or an alkali catalyst.

Examples of the acid catalyst include mineral acids such as hydrochloric acid, sulfuric acid, nitric acid, phosphoric acid, and boric acid; phosphoric acid esters; carboxylic acids such as acetic acid, formic acid, and trifluoroacetic acid; sulfonic acids such as methanesulfonic acid, trifluoromethanesulfonic acid, and p-toluenesulfonic acid; solid acids such as activated clay: Lewis acids such as iron chloride, and the like.

Examples of the alkali catalyst include alkali metal hydroxides such as lithium hydroxide, sodium hydroxide, potassium hydroxide, and cesium hydroxide; alkali earth metal hydroxides such as magnesium hydroxide, calcium hydroxide, and barium hydroxide; alkali metal carbonate such as lithium carbonate, sodium carbonate, potassium carbonate, and cesium carbonate; alkali earth metal carbonates such as magnesium carbonate: alkali metal hydrogen carbonates such as lithium hydrogen carbonate, sodium hydrogen carbonate, potassium hydrogen carbonate, and cesium hydrogen carbonate; alkali metal organic acid salts (for example, acetate) such as lithium acetate, sodium acetate, potassium acetate, and cesium acetate: alkali earth metal organic acid salts (for example, acetate) such as magnesium acetate; alkali metal alkoxides such as lithium methoxide, sodium methoxide, sodium ethoxide, sodium isopropoxide, potassium ethoxide, and potassium t-butoxide; alkali metal phenoxides such as sodium phenoxide; amines (tertiary amines and the like) such as triethylamine, N-methylpiperidine, 1,8-diazabicyclo[5.4.0]undec-7-ene, and 1,5-diazabicyclo[4.3.0]non-5-ene; nitrogen-containing aromatic heterocyclic compounds such as pyridine, 2,2′-bipyridyl, and 1,10-phenanthroline, and the like.

One kind of catalyst can be used singly, or two or more kinds of catalysts can be used in combination. Furthermore, the catalyst can be used in a state of being dissolved or dispersed in water, a solvent, or the like.

The amount of the catalyst used is not particularly limited, and can be appropriately adjusted within a range of 0.002 to 0.200 mol with respect to the total amount (1 mol) of the hydrolyzable silane compounds.

The amount of water used in the above hydrolysis and condensation reactions is not particularly limited, and can be appropriately adjusted within a range of 0.5 to 20 mol with respect to the total amount (1 mol) of the hydrolyzable silane compounds.

The method of adding water is not particularly limited. The entirety of water to be used (total amount of water to be used) may be added at once or added sequentially. In a case where water is added sequentially, the water may be added continuously or intermittently.

The reaction temperature of the hydrolysis and condensation reactions is, for example, 40° C. to 100° C. and preferably 45° C. to 80° C. The reaction time of the hydrolysis and condensation reactions is, for example, 0.1 to 10 hours and preferably 1.5 to 8 hours. Furthermore, the hydrolysis and condensation reactions can be carried out under normal pressure or under pressure that is increased or reduced. The hydrolysis and condensation reactions may be performed, for example, in any of a nitrogen atmosphere, an inert gas atmosphere such as argon gas atmosphere, or an aerobic atmosphere such as an air atmosphere. Among these, the inert gas atmosphere is preferable.

By the hydrolysis and condensation reactions of the hydrolyzable silane compounds described above, the polyorganosilsesquioxane of the present invention is obtained. After the hydrolysis and condensation reactions are finished, it is preferable to neutralize the catalyst so as to inhibit the ring opening of the oxetanyl group and the epoxy group. In addition, the polyorganosilsesquioxane of the present invention may be separated and purified by a separation method such as rinsing, acid cleaning, alkali cleaning, filtration, concentration, distillation, extraction, crystallization, recrystallization, or column chromatography, or by a separation method using these in combination.

<Polymerization Initiator>

The composition according to the embodiment of the present invention includes a polymerization initiator. In order that the polymerization reaction of the polyorganosilsesquioxane is initiated by light irradiation, it is preferable that the composition contains a cationic photopolymerization initiator as a polymerization initiator. One kind of cationic photopolymerization initiator may be used singly, or two or more kinds of cationic photopolymerization initiators having different structures may be used in combination.

Hereinafter, the cationic photopolymerization initiator will be described.

(Cationic Photopolymerization Initiator)

As the cationic photopolymerization initiator, known cationic photopolymerization initiators can be used without particular limitation, as long as the initiators can generate cations as active species by light irradiation. Specific examples thereof include known sulfonium salts, ammonium salts, iodonium salts (for example, diaryliodonium salts), triarylsulfonium salts, diazonium salts, iminium salts, and the like. More specifically, examples thereof include the cationic photopolymerization initiators represented by Formulas (25) to (28) described in paragraphs “0050” to “0053” of JP1996-143806A (JP-H08-143806A), the compounds exemplified as cationic polymerization catalysts in paragraph “0020” of JP1996-283320A (JP-H08-283320A), and the like. The cationic photopolymerization initiator can be synthesized by a known method or is available as a commercial product. Examples of the commercial product include CI-1370, CI-2064, CI-2397, CI-2624, CI-2639, CI-2734, CI-2758, CI-2823, CI-2855, CI-5102, and the like manufactured by NIPPON SODA CO., LTD., PHOTOINITIATOR 2047 and the like manufactured by Rhodia, UVI-6974 and UVI-6990 manufactured by Union Carbide Corporation, CPI-10P manufactured by San-Apro Ltd., and the like.

As the cationic photopolymerization initiator, in view of the sensitivity of the photopolymerization initiator with respect to light, the compound stability, and the like, a diazonium salt, an iodonium salt, a sulfonium salt, and an iminium salt are preferable. In view of weather fastness, an iodonium salt is most preferable.

Specific examples of commercial products of the iodonium salt-based cationic photopolymerization initiator include B2380 manufactured by TOKYO CHEMICAL INDUSTRY CO., LTD., BBI-102 manufactured by Midori Kagaku Co., Ltd., WPI-113, WPI-124, WPI-169, and WPI-170 manufactured by Wako Pure Chemical Industries, Ltd., and DTBPI-PFBS manufactured by Toyo Gosei Co., Ltd.

In addition, specific examples of the iodonium salt compound that can be used as the cationic photopolymerization initiator include the following compounds FK-1 and FK-2.

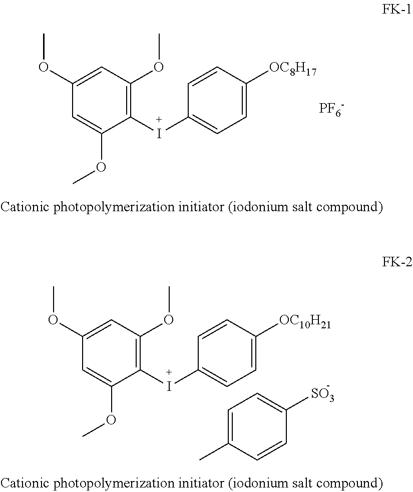

The content of the polymerization initiator in the composition according to the embodiment of the present invention is not particularly limited and may be appropriately adjusted within a range in which the polymerization reaction (cationic polymerization) of the polyorganosilsesquioxane excellently proceeds. The content of the cationic photopolymerization initiator with respect to 100 parts by mass of the polyorganosilsesquioxane is, for example, in a range of 0.1 to 200 parts by mass, preferably 1 to 150 parts by mass, and more preferably in a range of 2 to 100 parts by mass.

<Optional Components>

The composition according to the embodiment of the present invention can further include one or more kinds of optional components in addition to the polyorganosilsesquioxane and the polymerization initiators described above. Specific examples of the optional components include a solvent and various additives.

(Solvent)

As the solvent that can be included as an optional component, an organic solvent is preferable. One kind of organic solvent can be used singly, or two or more kinds of organic solvents can be used by being mixed together at any ratio. Specific examples of the organic solvent include alcohols such as methanol, ethanol, propanol, n-butanol, and i-butanol; ketones such as acetone, methyl isobutyl ketone, methyl ethyl ketone, and cyclohexanone; cellosolves such as ethyl cellosolve; aromatic solvents such as toluene and xylene; glycol ethers such as propylene glycol monomethyl ether; acetic acid esters such as methyl acetate, ethyl acetate, and butyl acetate: diacetone alcohol; and the like. The amount of the solvent in the aforementioned composition can be appropriately adjusted within a range in which the coating suitability of the composition can be ensured. For example, the amount of the solvent added with respect to the total amount (100 parts by mass) of the polyorganosilsesquioxane and the polymerization initiators can be 50 to 500 parts by mass, and preferably can be 80 to 200 parts by mass.

(Additives)

If necessary, the aforementioned composition can optionally include one or more kinds of known additives. Examples of such additives include a surface conditioner, a leveling agent, a polymerization inhibitor, and the like. For details of these, for example, paragraphs “0032” to “0034” of JP2012-229412A can be referred to. However, the additives are not limited to these, and it is possible to use various additives that can be generally used in a polymerizable composition. Furthermore, the amount of the additives added to the composition is not particularly limited and may be appropriately adjusted.

<Method of Preparing Composition>

The composition for forming a hardcoat layer according to the embodiment of the present invention can be prepared by simultaneously mixing together the various components described above or sequentially mixing together the various components described above in any order. The preparation method is not particularly limited, and the composition can be prepared using a known stirrer or the like.

[Hardcoat Film]

The hardcoat film according to an embodiment of the present invention has a substrate and a hardcoat layer formed on the substrate by using the composition for forming a hardcoat layer according to an embodiment of the present invention.

The hardcoat film according to the embodiment of the present invention is formed of the composition for forming a hardcoat layer using the polyorganosilsesquioxane described above. Therefore, the hardcoat film has high hardness, excellent rub resistance, and excellent resistance to repeated folding.

<Hardcoat Layer>

The hardcoat layer of the hardcoat film according to the embodiment of the present invention will be described. The hardcoat layer is formed of the composition for forming a hardcoat layer according to the embodiment of the present invention. That is, the hardcoat layer contains solid contents other than the solvent in the composition for forming a hardcoat layer.

(Film Thickness)

The film thickness of the hardcoat layer is not particularly limited. For example, as an embodiment, the film thickness of the hardcoat layer is preferably 1 to 50 μm, more preferably 3 to 30 μm, and even more preferably 5 to 20 μm. Furthermore, as another embodiment, the film thickness of the hardcoat layer is preferably 1 to 10 μm, more preferably 1.5 to 8 μm, and even more preferably 2 to 5 μm.

<Substrate>

The substrate of the hardcoat film according to the embodiment of the present invention will be described.

The transmittance of the substrate in a visible light region is preferably equal to or higher than 70%, and more preferably equal to or higher than 80%.

The substrate preferably includes a polymer resin. That is, the substrate is preferably a plastic substrate.

(Polymer Resin)

As the polymer resin, a polymer excellent in optical transparency, mechanical strength, heat stability, and the like is preferable.

Examples of such a polymer include polycarbonate-based polymers, polyester-based polymers such as polyethylene terephthalate (PET) and polyethylene naphthalate (PEN), styrene-based polymers such as polystyrene and an acrylonitrile/styrene copolymer (AS resin), and the like. The examples also include polyolefins such as polyethylene and polypropylene, norbornene-based resins, polyolefin-based polymers such as ethylene/propylene copolymers, vinyl chloride-based polymers, amide-based polymers such as nylon and aromatic polyamide, imide-based polymers, sulfone-based polymers, polyether sulfone-based polymers, polyether ether ketone-based polymers, polyphenylene sulfide-based polymers, vinylidene chloride-based polymers, vinyl alcohol-based polymers, vinyl butyral-based polymers, arylate-based polymers, polyoxymethylene-based polymers, epoxy-based polymers, cellulose-based polymers represented by triacetyl cellulose, copolymers of the above polymers, and polymers obtained by mixing together the above polymers.

Particularly, amide-based polymers such as aromatic polyamide and imide-based polymers can be preferably used as the substrate, because the number of times of folding at break measured for these polymers by an MIT tester according to JIS P8115 (2001) is large, and these polymers have relatively high hardness. For example, the aromatic polyamide described in Example 1 of JP5699454B and the polyimides described in JP2015-508345A and JP2016-521216A can be preferably used as the substrate.

The substrate can also be formed as a cured layer of an ultraviolet curable resin or a thermosetting resin based on acryl, urethane, acrylic urethane, epoxy, silicone, and the like.

(Softening Material)

The substrate may contain a material that further softens the polymer resin described above. The softening material refers to a compound that improves the number of times of folding at break. As the softening material, it is possible to use a rubber elastic material, a brittleness improver, a plasticizer, a slide ring polymer, and the like.

Specifically, as the softening material, the softening materials described in paragraphs “0051” to “0114” of JP2016-167043A can be suitability used.

The softening material may be mixed alone with the polymer resin, or a plurality of softening materials may be appropriately used in combination. Furthermore, the substrate may be prepared using one kind of softening material or a plurality of softening materials without being mixed with the resin.

The amount of the softening material mixed is not particularly limited as long as Equation (1) of JP2016-167043A is satisfied in a case where 10 parts by mass of the softening material is mixed with 100 parts by mass of the polymer resin. That is, a polymer resin having the sufficient number of times of folding at break may be used alone as the substrate of the film or may be mixed with the softening material, or the substrate may be totally (100%) composed of the softening material such that the number of times of folding at break becomes sufficient.

(Other Additives)

Various additives (for example, an ultraviolet absorber, a matting agent, an antioxidant, a peeling accelerator, a retardation (optical anisotropy) regulator, and the like) can be added to the substrate according to the use. These additives may be solids or oily substances. That is, the melting point or boiling point thereof is not particularly limited. In addition, the additives may be added at any point in time in the step of preparing the substrate, and a step of preparing a material by adding additives may be added to a material preparation step. Furthermore, the amount of each material added is not particularly limited as long as each material performs its function.

As those other additives, the additives described in paragraphs “0117” to “0122” of JP2016-167043A can be suitably used.

One kind of each of the above additives may be used singly, or two or more kinds of the above additives can be used in combination.

From the viewpoint of transparency, it is preferable that the difference between a refractive index of the softening material and various additives used in the substrate and a refractive index of the polymer resin is small.

(Thickness of Substrate)

The thickness of the substrate is more preferably equal to or smaller than 100 μm, even more preferably equal to or smaller than 60 μm, and most preferably equal to or smaller than 50 μm. In a case where the substrate has a small thickness, the difference in curvature between the front surface and the back surface of the folded substrate is reduced. Therefore, cracks and the like hardly occur, and the substrate is hardly broken even being folded plural times. On the other hand, from the viewpoint of ease of handling of the substrate, the thickness of the substrate is preferably equal to or greater than 10 μm, and more preferably equal to or greater than 15 μm. From the viewpoint of reducing the thickness of the image display device into which the optical film is to be incorporated, the total thickness of the optical film is preferably equal to or smaller than 70 μm, and more preferably equal to or smaller than 50 μm.

(Method for Preparing Substrate)

The substrate may be prepared by heat-melting a thermoplastic polymer resin, or may be prepared from a solution, in which a polymer is uniformly dissolved, by solution film formation (a solvent casting method). In the case of heat-melting film formation, the softening material and various additives described above can be added during heat melting. In contrast, in a case where the substrate is prepared by the solution film formation method, the softening material and various additives described above can be added to the polymer solution (hereinafter, also referred to as dope) in each preparation step. Furthermore, the softening material and various additives may be added at any point in time in a dope preparation process. In the dope preparation process, a step of preparing the dope by adding the additives may be additionally performed as a final preparation step.

<Other Layers>

The hardcoat film according to the embodiment of the present invention may have layers other than the hardcoat layer.

For example, it is preferable that an anti-scratch layer is provided on the outermost surface of the hardcoat film that is opposite to the substrate of the hardcoat layer. In a case where the anti-scratch layer is provided, rub resistance can be improved.

(Anti-Scratch Layer)

In the anti-scratch layer, the content of a cured product of a crosslinkable compound having three or more crosslinking groups in one molecule is preferably equal to or greater than 80% by mass with respect to the total mass of the anti-scratch layer.

The crosslinkable compound having three or more crosslinking groups in one molecule may be a crosslinkable monomer, a crosslinkable oligomer, or a crosslinkable polymer. In a case where the crosslinkable compound has three or more crosslinking groups in one molecule, a dense three-dimensional crosslinked structure is easily formed. Therefore, even though the used crosslinkable compound has a small crosslinking group equivalent (referred to as acryl equivalent in a case where the compound has a (meth)acryloyl group as a crosslinking group), the indentation hardness of the anti-scratch layer can be increased. The indentation hardness of the anti-scratch layer is preferably equal to or higher than 300 MPa.

The content rate of the cured product of the crosslinkable compound having three or more crosslinking groups in one molecule with respect to the total mass of the anti-scratch layer is preferably equal to or higher than 80% by mass, more preferably equal to or higher than 85% by mass, and even more preferably equal to or higher than 90% by mass.

The crosslinking group is preferably a (meth)acryloyl group, an epoxy group, or an oxetanyl group, more preferably a (meth)acryloyl group or an epoxy group, and most preferably a (meth)acryloyl group.

Examples of the crosslinkable monomer having three or more crosslinking groups in one molecule include esters of a polyhydric alcohol and a (meth)acrylic acid. Specifically, examples thereof include pentaerythritol tri(meth)acrylate, pentaerythritol tetra(meth)acrylate, trimethylolpropane tri(meth)acrylate, trimethylolethane tri(meth)acrylate, ditrimethylolpropane tetra(meth)acrylate, dipentaerythritol tetra(meth)acrylate, dipentaerythritol pentaacrylate, dipentaerythritol hexaacrylate, pentaerythritol hexa(meth)acrylate, and the like. In view of high degree of crosslinking, pentaerythritol triacrylate, pentaerythritol tetraacrylate, dipentaerythritol pentaacrylate, dipentaerythritol hexaacrylate, or a mixture of these is preferable.

The film thickness of the anti-scratch layer is preferably equal to or smaller than 350 nm.

[Method for Manufacturing Hardcoat Film]

The method for manufacturing a hardcoat film according to an embodiment of the present invention will be described.

The method for manufacturing a hardcoat film according to the embodiment of the present invention is preferably a manufacturing method including the following steps (I) and (II).

(I) Step of coating a substrate with the composition for forming a hardcoat layer according to the embodiment of the present invention so as to form a coating film on the substrate

(II) Step of performing a curing treatment on the coating film so as to form a hardcoat layer

<Step (I)>

Step (I) is a step of coating a substrate with the composition for forming a hardcoat layer so as to form a coating film on the substrate.

The substrate and the composition for forming a hardcoat layer are as described above.

As the method of coating a substrate with the composition for forming a hardcoat layer, known methods can be used without particular limitation. Examples thereof include a dip coating method, an air knife coating method, a curtain coating method, a roller coating method, a wire bar coating method, a gravure coating method, a die coating method, and the like.

<Step (II)>

The step (II) is a step of performing a curing treatment on the coating film so as to form a hardcoat layer.

The coating film is preferably cured by radiating ionizing radiation to the coating film side or cured by heat.

The type of ionizing radiation is not particularly limited, and examples thereof include X-rays, electron beams, ultraviolet, visible light, infrared, and the like. Among these, ultraviolet is preferably used. For example, in a case where the coating film can be cured by ultraviolet, it is preferable to irradiate the coating film with ultraviolet from an ultraviolet lamp at an irradiation dose of 10 mJ/cm² to 1,000 mJ/cm² such that the curable compound is cured. The irradiation dose is more preferably 50 mJ/cm² to 1,000 mJ/cm², and even more preferably 100 mJ/cm² to 500 m/cm². As the ultraviolet lamp, a metal halide lamp, a high-pressure mercury lamp, or the like is suitably used.

In a case where the coating film is cured by heat, the temperature is not particularly limited, but is preferably equal to or higher than 80° C. and equal to or lower than 200° C., more preferably equal to or higher than 100° C. and equal to or lower than 180° C., and even more preferably equal to or higher than 120° C. and equal to or lower than 160° C.

The oxygen concentration during curing is preferably 0% to 1.0% by volume, more preferably 0% to 0.1% by volume, and most preferably 0% to 0.05% by volume. In a case where the oxygen concentration during curing is lower than 1.0% by volume, oxygen hardly affects and hinders curing, and thus a hard film is obtained.

If necessary, at either or both of a stage that follows the step (I) and precedes the step (II) and a stage that follows the step (II), a drying treatment may be performed. The drying treatment can be performed by blowing hot air, disposing the film in a heating furnace, transporting the film in a heating furnace, and the like. The heating temperature is not particularly limited and may be set to a temperature at which the solvent can be dried and removed. The heating temperature means the temperature of hot air or the internal atmospheric temperature of the heating furnace.

In the method for manufacturing a hardcoat film, after the step (II), it is also preferable to coat the hardcoat layer with a composition for forming an anti-scratch layer and curing the composition so as to form an anti-scratch layer.

The present invention also relates to an article having the above hardcoat film according to the embodiment of the present invention described above and an image display device having the hardcoat film according to the embodiment of the present invention described above (preferably an image display device having the hardcoat film according to the embodiment of the present invention as a surface protection film). The hardcoat film according to the embodiment of the present invention is particularly preferably applied to flexible displays in smartphones and the like.

### EXAMPLES

Hereinafter, the present invention will be more specifically described using examples, but the scope of the present invention is not limited thereto. Unless otherwise specified, “part” and “%” are based on mass.

(Silane Compound Used for Synthesizing Polyorganosilsesquioxane)

Silane compounds used for synthesizing the polyorganosilsesquioxane used in the present invention are as follows.

—Oxetanyl Group-Containing Silane Compound—

Compound (A-1): 7-trimethoxysilyl-4-thiaheptanoic acid-(3-ethyl-oxetan-3-yl) was synthesized by the method described in JP1998-330485A (JP-H10-330485A).

Compound (A-2): (3-ethyl-oxetan-3-yl)methyloxypropyltriethoxysilane (TESOX) was synthesized by the method described in TOAGOSEI annual research report TREND, No. 3 (1999), pp. 27-33.

Comparative compound (A-1x): N-(3-triethoxysilylpropyl)-(3-ethyl-oxetan-3-yl)-methylcarbamate was synthesized by the method described in JP1998-330485A (JP-H10-330485A).

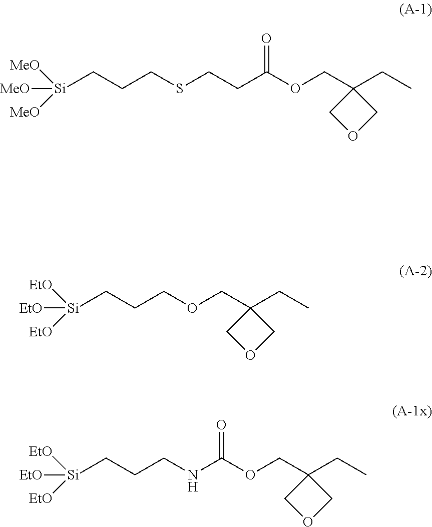 [SMILES: CCC1(COC(=O)CCSCCC[Si](OC)(OC)OC)COC1 ; CCO[Si](CCCOCC1(CC)COC1)(OCC)OCC ; CCO[Si](CCCNC(=O)OCC1(CC)COC1)(OCC)OCC]

—Epoxy Group-Containing Silane Compound—

Compound (B-1): 2-(3,4-epoxycyclohexyl)ethyltrimethoxysilane manufactured by TOKYO CHEMICAL INDUSTRY CO., LTD. was used.

Compound (B-2): 3-glycidyloxypropyltrimethoxysilane manufactured by TOKYO CHEMICAL INDUSTRY CO., LTD. was used.

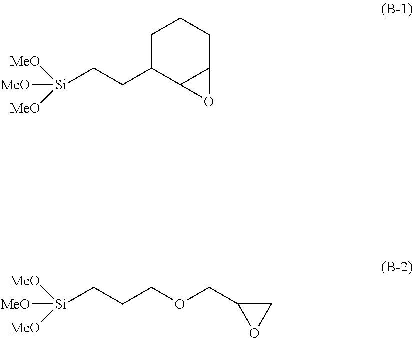 [SMILES: CO[Si](CCC1CCCC2OC12)(OC)OC ; CO[Si](CCCOCC1CO1)(OC)OC]

—Other Silane Compounds—

Compound (C-1): 1,6-bis(trimethoxysilyl)hexane manufactured by TOKYO CHEMICAL INDUSTRY CO., LTD. was used.

Compound (C-2): 1,2-bis(trimethoxysilyl)ethane manufactured by TOKYO CHEMICAL INDUSTRY CO., LTD. was used.

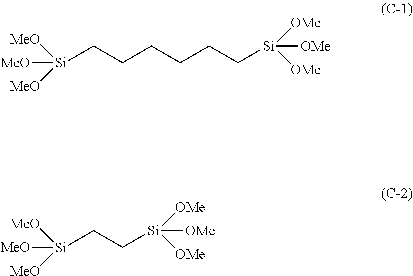 [SMILES: CO[Si](CCCCCC[Si](OC)(OC)OC)(OC)OC ; CO[Si](CC[Si](OC)(OC)OC)(OC)OC]

### Preparation Example 1

—Synthesis of Polyorganosilsesquioxane (PSQ-1)—

In a nitrogen atmosphere, 38.12 g (104 mmol) of 7-trimethoxysilyl-4-thiaheptanoic acid-(3-ethyl-oxetan-3-yl) (the compound (A-1)), 13.80 g (56 mmol) of 2-(3,4-epoxycyclohexyl)ethyltrimethoxysilane (the compound (B-1)), and 160 g of acetone were stirred at 50° C. While the mixture was being stirred, 4.42 g of a 5% aqueous potassium carbonate solution was added dropwise thereto for 5 minutes. Furthermore, 28.8 g of pure water was added dropwise thereto for 20 minutes, and the mixture was stirred as it was at 50° C. for 5 hours.

The reaction solution was returned to room temperature (20° C.), and then 160 g of methyl isobutyl ketone (MIBK) and 160 g of a 5% saline were added thereto. The mixture was transferred to a separatory funnel, and the organic layer was extracted and washed with 160 g of a 5% saline and washed twice with 160 g of pure water in this order. The organic layer was concentrated under reduced pressure, thereby obtaining 46.78 g of an MIBK solution containing 59.8% by mass of polyorganosilsesquioxane (PSQ-1) (yield: 71%). The weight-average molecular weight (Mw) of the obtained polyorganosilsesquioxane compound (PSQ-1) was 2,900.

The weight-average molecular weight of the polyorganosilsesquioxane was measured using the following device under the following conditions.

Measurement device: trade name “LC-20AD” (manufactured by Shimadzu Corporation)

Columns: two Shodex KF-801 columns, KF-802, and KF-803 (manufactured by SHOWA DENKO K.K.)

Measurement temperature: 40° C.

Eluent: THF sample concentration of 0.1% to 0.2% by mass

Flow rate: 1 mL/min

Detector: UV-VIS detector (trade name “SPD-20A”, manufactured by Shimadzu Corporation)

Molecular weight: expressed in terms of standard polystyrene

### Preparation Examples 2 to 4 and Comparative Preparation Examples 1 to 4

MIBK solutions containing polyorganosilsesquioxanes (PSQ-2) to (PSQ-4) and (PSQ-1x) to (PSQ-4x) used in examples and comparative examples of the present invention were prepared in the same manner as in Preparation Example 1, except that the silane compounds used and the mixing ratio thereof in Preparation Example 1 were changed as shown in Table 1. The weight-average molecular weights of the obtained polyorganosilsesquioxanes are also listed in Table 1. The mixing ratio in the following Table 1 represents a mixing ratio among a silane compound having an oxetanyl group, a silane compound having an epoxy group, and another silane compound in this order from the left.

TABLE 11

| | Silane compound | Silane compound | Other silane | Mixing ratio | | | |
|---|---|---|---|---|---|---|---|
| Polyorganosilsesquioxane | having oxetanyl group | having epoxy group | compounds | (molar ratio) | p/q | (p + q)/(p + q + r) | Mw |
| PSQ-1 | A-1 | B-1 | — | 65:35 | 1.9 | 1.0 | 2,900 |
| PSQ-2 | A-1 | B-1 | C-1 | 49.5:49.5:1 | 1.0 | 0.98 | 4,700 |
| PSQ-3 | A-2 | B-1 | C-2 | 70:29:1 | 2.4 | 0.98 | 5,300 |
| PSQ-4 | A-2 | B-2 | C-1 | 90:8:2 | 11.3 | 0.96 | 6,200 |
| PSQ-1x | A-2 | — | — | — | — | — | 3,000 |
| PSQ-2x | — | B-2 | — | — | — | — | 3,900 |
| PSQ-3x | A-1x | B-1 | — | 50:50 | 1.0 | 1.0 | 3,400 |
| PSQ-4x | A-2 | B-2 | — | 25:75 | 0.3 | 1.0 | 2,900 |

### Example 1

### (Preparation of Composition 1 for Forming Hardcoat Layer)

CPI-100P (cationic photopolymerization initiator, manufactured by San-Apro Ltd.), SAN-AID SI-B2A (cationic thermal polymerization initiator, manufactured by Sanshin chemical industry CO., LTD.), MEGAFACE F-554 (leveling agent, manufactured by DIC Corporation), and MIBK were added to the MIBK solution containing the polyorganosilsesquioxane (PSQ-1) obtained in the synthesis example described above so as to adjust the concentration of each component contained in the composition as shown in the following Table 2, thereby obtaining a composition 1 for forming a hardcoat layer. In the following Table 2, the content of each of the polvorganosilsesquioxane, CPI-100P, SAN-AID SI-B2A, and MEGAFACE F-554 is an amount with respect to the total solid content (all components other than solvents) in the composition 1 for forming a hardcoat layer. The solid content means the total content (concentration of solid contents) of solids with respect to the total mass of the composition 1 for forming a hardcoat layer.

TABLE 2

| | | |
|---|---|---|
| Polyorganosilsesquioxane | PSQ-1 | 93.60% |
| Pholopolymerization initiator | CPI-100P | 1.30% |
| Thermal polymerization initiator | SAN-AID SI-B2A | 5.00% |
| Leveling agent | MEGAFACE F-554 | 0.10% |

| | |
|---|---|
| Solid contents | 50% |

[Preparation of Substrate]

(Manufacturing of Polyimide Powder)

Under a nitrogen stream, 832 g of N,N-dimethylacetamide (DMAc) was added to a 1 L reactor equipped with a stirrer, a nitrogen injection device, a dropping funnel, a temperature controller, and a cooler, and then the temperature of the reactor was set to 25° C. Bistrifluoromethylbenzidine (TFDB) (64.046 g (0.2 mol)) was added thereto and dissolved. The obtained solution was kept at 25° C. and in this state, 31.09 g (0.07 mol) of 2,2-bis(3,4-dicarboxyphenyl)hexafluoropropane dianhydride (6FDA) and 8.83 g (0.03 mol) of biphenyltetracarboxylic dianhydride (BPDA) were added thereto, and the mixture was allowed to react by being stirred for a certain period of time. Then, 20.302 g (0.1 mol) of terephthaloyl chloride (TPC) was added thereto, thereby obtaining a polyamic acid solution with a concentration of solid contents of 13% by mass. Thereafter, 25.6 g of pyridine and 33.1 g of acetic anhydride were added to the polyamic acid solution, and the mixture was stirred for 30 minutes, further stirred at 70° C. for 1 hour, and then cooled to room temperature. Methanol (20 L) was added thereto, and the precipitated solid contents were filtered and ground. Subsequently, the ground resultant was dried in a vacuum at 100° C. for 6 hours, thereby obtaining 111 g of polyimide powder.

(Preparation of Substrate S-1)

The polyimide powder (100 g) was dissolved in 670 g of N,N-dimethylacetamide (DMAc), thereby obtaining a 13% by mass solution. The obtained solution was cast on a stainless steel plate and dried with hot air at 130° C. for 30 minutes. Then, the film was peeled from the stainless steel plate and fixed to a frame by using pins, and the frame to which the film was fixed was put in a vacuum oven, heated for 2 hours by slowly increasing the heating temperature up to 300° C. from 100° C., and then slowly cooled. The cooled film was separated from the frame. Then, as a final heat treatment step, the film was further treated with heat for 30 minutes at 300° C., thereby obtaining a substrate S-1 having a film thickness of 30 μm consisting of a polyimide film.

(Manufacturing of Hardcoat Film)

The polyimide substrate S-1 having a thickness of 30 μm was coated with the composition for forming a hardcoat layer by using a #26 wire bar such that the film thickness became 17 μm after curing. After coating, the coating film was heated at 120° C. for 5 minutes. Then, from a position 18 cm above the surface of the coating film, ultraviolet was radiated to the coating film by using a high-pressure mercury lamp at a cumulative irradiation dose of 600 mJ/cm². Furthermore, the coating film was heated at 140° C. for 3 hours, thereby curing the coating film. In this way, a hardcoat film was prepared which had a hardcoat layer on a substrate film.

### Examples 2 to 4 and Comparative Examples 1 to 4

Compositions for forming a hardcoat layer and hardcoat films of Examples 2 to 4 and Comparative Examples 1 to 4 were obtained in the same manner as in Example 1, except that the MIBK solution including the polyorganosilsesquioxane (PSQ-1) was changed to MIBK solutions including (PSQ-2) to (PSQ-4) and (PSQ-1x) to (PSQ-4x).

[Evaluation]

The obtained hardcoat films were evaluated for the following items.

(Pencil Hardness)

Pencil hardness was evaluated according to JIS (JIS stands for Japanese Industrial Standards) K5400. The hardcoat films of examples and comparative examples were humidified for 2 hours at a temperature of 25° C. and a relative humidity of 60%. Then, 5 different sites within the surface of the hardcoat layer were scratched using H to 9H testing pencils specified in JIS S 6006 under a load of 4.9 N. Thereafter, among the hardnesses of pencils found to leave visually recognized scratches at 0 to 2 sites, the highest pencil hardness was adopted as an evaluation result and described by being evaluated according to the following three standards A to C. For the pencil hardness, the higher the numerical value described before “H”, the higher the hardness, which is preferable.

A: equal to or higher than 5H

B: 4H

C: equal to or lower than 3H

(Resistance to Repeated Folding)

In order to evaluate the flexibility of the hardcoat films manufactured in examples and comparative examples, a bending test at a bend radius of 2.0 mm was repeated on the hardcoat films with the hardcoat layer facing inwards, and whether or not cracks occurred by the test was checked. The results were evaluated based on the following three standards A to C.

A: No cracks occurred even after the hardcoat film was bent 500,000 times or more.

B: Cracks occurred at a point in time when the number of times of bending was equal to or greater than 100,000 and less than 500,000.

C: Cracks occurred before the hardcoat film was bent 100,000 times.

(Rub Resistance)

In an environment at a temperature of 25° C. and a relative humidity of 60%, steel wool (manufactured by NIHON STEEL WOOL Co., Ltd., No. 0) was wound around the tip rubbing portion (1 cm×1 cm), which will contact an evaluation target (hardcoat film), of a rubbing tester and fixed using a band so as to prevent the steel wool from moving. Then, the surface of the hardcoat layer of the hardcoat film of each of the examples and comparative examples was rubbed under the following conditions.

Moving distance (one way): 13 cm,

Rubbing speed: 13 cm/sec,

Load: 200 g,

Contact area of tip portion: 1 cm×1 cm.

After the test, an oil-based black ink was applied to the surface, which was opposite to the hardcoat layer, of the hardcoat film of each of the examples and the comparative examples. The reflected light was visually observed, the number of times of rubbing that caused scratches in the portion contacting the steel wool was counted, and the rub resistance was evaluated based on the following three standards.

A: No scratch was made even after the hardcoat film was rubbed 100 times.

B: No scratch was made even after the hardcoat film was rubbed 10 times, but while the hardcoat film was being rubbed 100 times, scratches were made.

C: While the hardcoat film was being rubbed 10 times, scratches were made.

TABLE 3

| | Pencil | Resistance to | Rub |
|---|---|---|---|
| | hardness | repeated folding | resistance |
| Example 1 | B | A | A |
| Example 2 | B | A | A |
| Example 3 | A | B | A |
| Example 4 | B | A | |
| Comparative | C | B | C |
| Example 1 | | | |
| Comparative | C | A | C |
| Example 2 | | | |
| Comparative | C | C | C |
| Example 3 | | | |
| Comparative | C | B | C |
| Example 4 | | | |

From the results shown in Table 3, it has been found that the hardcoat films of the examples of the present invention have high hardness, excellent resistance to repeated folding, and excellent rub resistance.

According to the present invention, it is possible to provide a composition for forming a hardcoat layer that has high hardness, excellent resistance to repeated folding, and excellent rub resistance, a hardcoat film formed of the composition for forming a hardcoat layer, an article and an image display device that have the hardcoat film, and a method for manufacturing the hardcoat film.

The present invention has been described in detail with reference to specific embodiments. To those skilled in the art, it is obvious that various changes or modifications can be added without departing from the gist and scope of the present invention.

What is claimed is:

1. A composition for forming a hardcoat layer, comprising:
a polyorganosilsesquioxane; and
a polymerization initiator,
wherein the polyorganosilsesquioxane has, at least, a siloxane constitutional unit containing an oxetanyl group and a siloxane constitutional unit containing an epoxy group and is represented by the following General Formula (1), 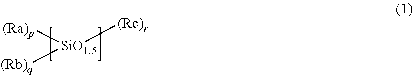
wherein, in the General Formula (1), Ra represents a group containing an oxetanyl group; Rb represents a group containing an epoxy group; Rc represents a monovalent substituent; Ra, Rb, and Rc each have a structure including none of an amide bond, a urea bond, and a urethane bond; p and q represent an integer equal to or greater than 1; r represents an integer equal to or greater than 0; p/q is equal to or greater than 1.0 and less than 99; in a case where each of p, q, and r is an integer equal to or greater than 2, a plurality of Ra's may be the same as or different from each other, a plurality of Rb's may be the same as or different from each other, and a plurality of Rc's may be the same as or different from each other; and in a case where r is an integer equal to or greater than 2, a plurality of Rc's may form a bond with each other.

2. The composition for forming a hardcoat layer according to claim 1,
wherein, in the General Formula (1), (p+q)(p+q+r) is 0.5 to 1.0.

3. The composition for forming a hardcoat layer according to claim 1,
wherein Ra in the General Formula (1) is a group represented by the following General Formula (1a), 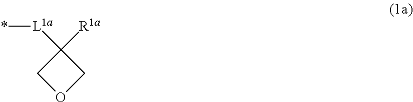
wherein, in the General Formula (1a), * represents a portion linked to Si in the General Formula (1), L^{1a} represents a divalent linking group, R^{1a} represents a substituted or unsubstituted alkyl group having 1 to 6 carbon atoms, and L^{1a} includes none of an amide bond, a urea bond, and a urethane bond.

4. The composition for forming a hardcoat layer according to claim 2,
wherein Ra in the General Formula (1) is a group represented by the following General Formula (1a), 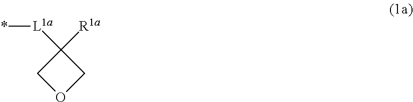
wherein, in the General Formula (1a), * represents a portion linked to Si in the General Formula (1), L^{1a} represents a divalent linking group, R^{1a} represents a substituted or unsubstituted alkyl group having 1 to 6 carbon atoms, and L^{1a} includes none of an amide bond, a urea bond, and a urethane bond.

5. The composition for forming a hardcoat layer according to claim 1,
wherein Rb in the General Formula (1) is a group having a condensed ring structure of an epoxy group and an alicyclic group.

6. The composition for forming a hardcoat layer according to claim 2,
wherein Rb in the General Formula (1) is a group having a condensed ring structure of an epoxy group and an alicyclic group.

7. The composition for forming a hardcoat layer according to claim 3,
wherein Rb in the General Formula (1) is a group having a condensed ring structure of an epoxy group and an alicyclic group.

8. The composition for forming a hardcoat layer according to claim 4,
wherein Rb in the General Formula (1) is a group having a condensed ring structure of an epoxy group and an alicyclic group.

9. The composition for forming a hardcoat layer according to claim 1,
wherein Rb in the General Formula (1) is a group having an epoxycyclohexyl group.

10. The composition for forming a hardcoat layer according to claim 2,
wherein Rb in the General Formula (1) is a group having an epoxycyclohexyl group.

11. The composition for forming a hardcoat layer according to claim 3,
wherein Rb in the General Formula (1) is a group having an epoxycyclohexyl group.

12. The composition for forming a hardcoat layer according to claim 1,
wherein, in the General Formula (1), r is an integer equal to or greater than 2, a plurality of Rc's form a bond with each other, and r/(p+q+r) is 0.005 to 0.20.

13. The composition for forming a hardcoat layer according to claim 2,
wherein, in the General Formula (1), r is an integer equal to or greater than 2, a plurality of Rc's form a bond with each other, and r/(p+q+r) is 0.005 to 0.20.

14. The composition for forming a hardcoat layer according to claim 3,
wherein, in the General Formula (1), r is an integer equal to or greater than 2, a plurality of Rc's form a bond with each other, and r/(p+q+r) is 0.005 to 0.20.

15. The composition for forming a hardcoat layer according to claim 1,
wherein a weight-average molecular weight of the polyorganosilsesquioxane is 2,000 to 20,000.

16. A hardcoat film comprising:
a substrate; and
a hardcoat layer which is on the substrate and formed of the composition for forming a hardcoat layer according to claim 1.

17. The hardcoat film according to claim 16,
wherein the substrate is a plastic substrate.

18. An article comprising:
the hardcoat film according to claim 16.

19. An image display device comprising:
the hardcoat film according to claim 16 as a surface protection film.

20. A method for manufacturing a hardcoat film, comprising:
(I) coating a substrate with the composition for forming a hardcoat layer according to claim 1 so as to form a coating film on the substrate; and
(II) performing a curing treatment on the coating film so as to form a hardcoat layer.
